(19) United States
(12) Patent Application Publication
(10) Pub. No.: US 2021/0102756 A1
(43) Pub. Date: Apr. 8, 2021

(54) HEAT EXCHANGER WITH INTERLEAVED MANIFOLDS AND LAYERED CORE

(71) Applicant: Hamilton Sundstrand Corporation, Charlotte, NC (US)

(72) Inventors: Ahmet T. Becene, West Simsbury, CT (US); Gabriel Ruiz, Granby, CT (US); Nigel G. M. Palmer, West Granby, CT (US); Jessica M. Blamick, Enfield, CT (US)

(21) Appl. No.: 16/593,610

(22) Filed: Oct. 4, 2019

(51) Int. Cl. F28D 7/00; F28F 1/04; B33Y 80/00

(52) U.S. Cl. CPC F28D 7/0016; B33Y 80/00; F28F 1/04

(57) ABSTRACT

A heat exchanger includes a core, a first manifold, and a second manifold. The first and second manifolds include a primary fluid channel extending between a fluid port and a first branched region, a plurality of secondary fluid channels fluidly connected to the primary fluid channel at the first branched region, and a first overlap region of the plurality of secondary fluid channels downstream of the first branched region and connected to the core. The plurality of secondary fluid channels are interleaved at the first overlap region such that a first layer of secondary fluid channels of the first manifold forms a first flow layer within the core, a first layer of secondary fluid channels of the second manifold forms a second flow layer within the core, and the first flow layer is adjacent and parallel to the second flow layer.

### BACKGROUND

This disclosure relates generally to heat exchangers, and more specifically to an interface between a heat exchanger manifold and core.

Heat exchangers are well known in many industries for a variety of applications. Heat exchangers that operate in high temperature environments, such as in modern aircraft engines, can have reduced service lives due to high thermal stress. Thermal stress can be caused by uneven temperature distribution within the heat exchanger or with abutting components, component stiffness and geometry discontinuity, and/or other material properties of the heat exchanger. The interface between an inlet/outlet manifold and the core of a heat exchanger can be subject to the highest thermal stress and the shortest service life.

In mobile applications, particularly for aerospace applications, it is desirable to use heat exchangers that provide a compact, low-weight, and highly-effective means of exchanging heat from a hot fluid to a cold fluid. Additive manufacturing techniques can be utilized to manufacture heat exchangers layer by layer to obtain a variety of complex geometries that may be desirable for such applications.

### SUMMARY

In one example, a heat exchanger includes a core, a first manifold, and a second manifold. The first manifold includes a primary fluid channel extending between a fluid port and a first branched region, a plurality of secondary fluid channels fluidly connected to the primary fluid channel at the first branched region, and a first overlap region of the plurality of secondary fluid channels downstream of the first branched region and connected to the core at a first transition region. The second manifold includes a primary fluid channel extending between a fluid port and a first branched region, a plurality of secondary fluid channels fluidly connected to the primary fluid channel at the first branched region, and a first overlap region of the plurality of secondary fluid channels downstream of the first branched region and connected to the core at a first transition region. The plurality of secondary fluid channels of the first and second manifolds are interleaved at the first overlap region such that a first layer of secondary fluid channels of the first manifold forms a first flow layer within the core, a first layer of secondary fluid channels of the second manifold forms a second flow layer within the core, and the first flow layer is adjacent and parallel to the second flow layer.

In another example, a heat exchanger core includes a plurality of cold flow layers extending between a cold inlet manifold and a cold outlet manifold and a plurality of hot flow layers extending between a hot inlet manifold and a hot outlet manifold. The plurality of hot flow layers and the plurality of cold flow layers are interleaved to form alternating hot and cold flow layers of the core.

### BRIEF DESCRIPTION OF THE DRAWINGS

FIG. 1A is a partial cut-away isometric view showing a front view of a heat exchanger with interleaved hot and cold flow layers.

FIG. 1B is partial cut-away isometric view showing a rear view of a heat exchanger with interleaved hot and cold flow layers.

FIG. 2 is a cross-sectional view of a honeycomb core of a heat exchanger taken at plane A-A.

FIG. 3 is an isometric view of a heat exchanger including inlet and outlet manifolds and hot and cold flow layers.

### DETAILED DESCRIPTION

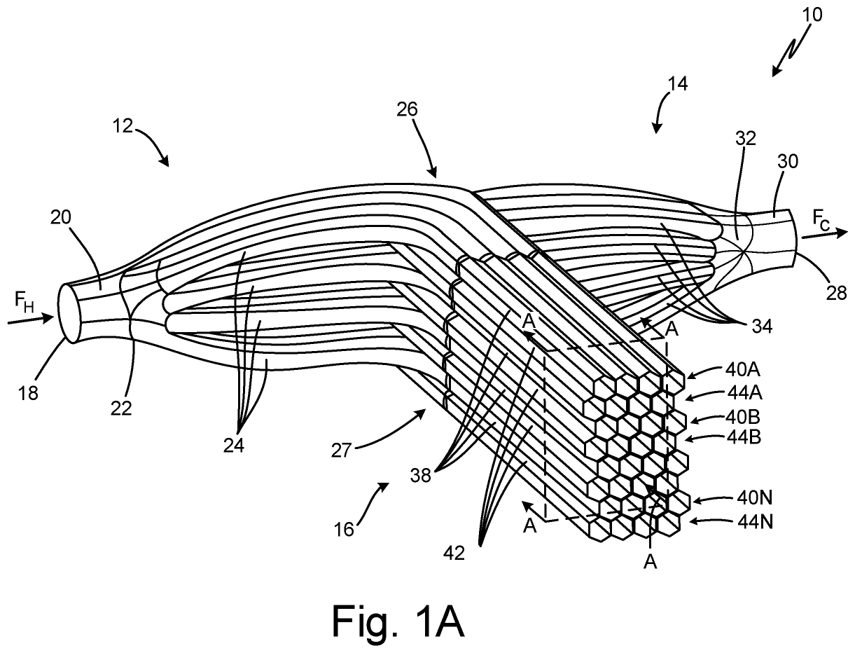

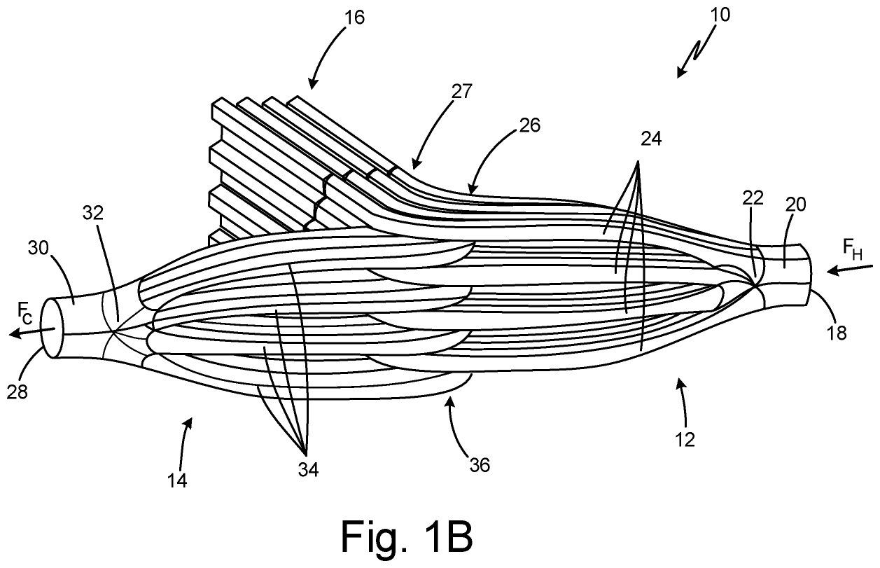

A heat exchanger with interleaved manifolds and a layered core is disclosed herein. The heat exchanger includes at least two branched tubular manifolds mated to a honeycomb core. The manifolds can have a fractal geometry such that there is a fractal relationship between consecutive levels of branching tubes within each manifold. That is, each consecutive level of tubes within the manifolds can be nearly the same as the previous level. The interleaved structure of the manifolds and core enables the heat exchanger to be additively manufactured as a single unit. The heat exchanger is described below with reference to FIGS. 1A-3.

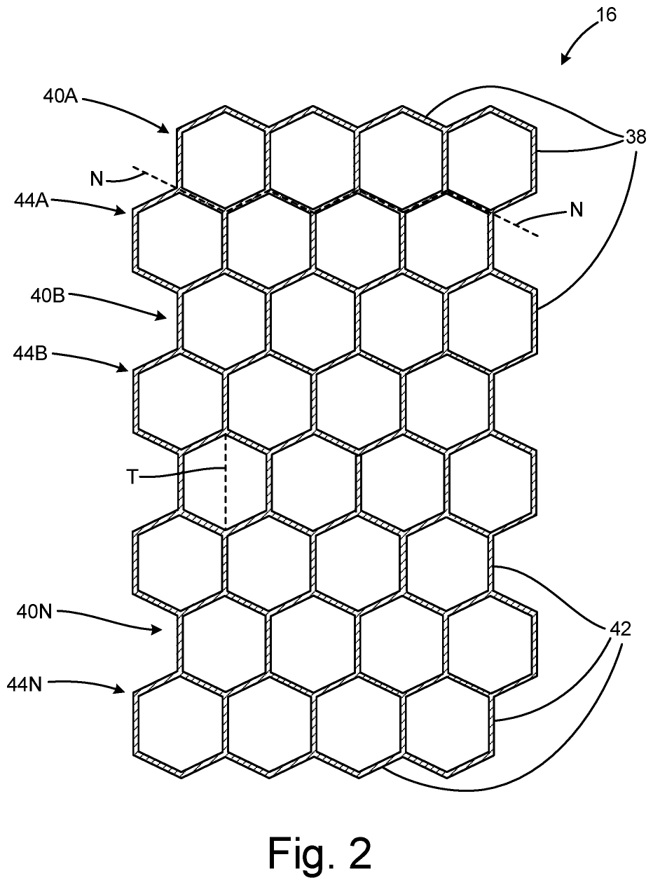

For purposes of clarity and ease of discussion, FIGS. 1A, 1B, and 2 will be described together. FIG. 1A is a partial cut-away isometric view showing a front view of heat exchanger 10 with interleaved hot and cold flow layers. FIG. 1B is partial cut-away isometric view showing a rear view of heat exchanger 10. FIG. 2 is a cross-sectional view of heat exchanger 10. Heat exchanger 10 includes hot manifold 12 and cold manifold 14 fluidly connected to core 16. (“Hot” and “cold” designations herein are used to refer to the relative temperature of fluid flowing through the hot and cold manifolds, respectively, but the designations can be reversed in alternative embodiments).

Hot manifold 12 includes hot fluid port 18, hot primary fluid channel 20, hot branched region 22, hot secondary fluid channels 24, and hot overlap region 26. Transition region 27 forms an interface between hot manifold 12, cold manifold 14, and core 16. Cold manifold 14 similarly includes cold fluid port 28, cold primary fluid channel 30, cold branched region 32, cold secondary fluid channels 34, and cold overlap region 36. Core 16 includes hot core channels 38 within hot flow layers 40A-40N (“N” is used herein as an arbitrary integer) and cold core channels 42 within cold flow layers 44A-44N. Heat exchanger 10 interacts with hot fluid F_{H} at hot manifold 12 and with cold fluid F_{C} at cold manifold 14.

Hot fluid port 18 forms an opening into the fluid system of hot manifold 12. Specifically, hot fluid port 18 is configured as an opening into hot primary fluid channel 20. Hot primary fluid channel 20 forms a first section of hot manifold 12. Hot primary fluid channel 20 extends between hot fluid port 18 and hot branched region 22. Hot branched region 22 forms an end of hot primary fluid channel 20 distal to hot fluid port 18.

Hot secondary fluid channels 24 are fluidly connected to hot primary fluid channel 20 at hot branched region 22. Though the examples of FIGS. 1A and 1B show hot branched region 22 branching into four distinct layers of four hot secondary fluid channels 24, it should be understood that in other examples, alternate configurations are possible, including more or fewer hot secondary fluid channels 24 extending from hot branched region 22. Furthermore, hot secondary fluid channels 24 can extend radially from hot branched region 22 along a single plane or along multiple planes (to form a layered structure as shown in FIGS. 1A and 1B).

Hot secondary fluid channels 24 extend between hot branched region 22 of hot manifold 12 and core 16. Hot secondary fluid channels 24 can form a relatively straight path between hot branched region 22 and core 16 (i.e., so that hot manifold 12 and core 16 are oriented at 180 degrees) or the path can be curved, for example, as shown in FIGS. 1A and 1B at overlap region 26. Though the examples of FIGS. 1A and 1B show hot secondary fluid channels 24 turning 90 degrees to interface with core 16, it should be understood that in other examples, the angle between hot secondary fluid channels 24 and core 16 need not be 90 degrees.

As shown in FIGS. 1A and 1B, cold manifold 14 can have a substantially similar configuration to hot manifold 12. Cold fluid port 28 forms an opening into the fluid system of cold manifold 14. Specifically, cold fluid port 28 is configured as an opening into cold primary fluid channel 30. Cold primary fluid channel 30 forms a first section of cold manifold 14. Cold primary fluid channel 30 extends between cold fluid port 28 and cold branched region 32. Cold branched region 32 forms an end of cold primary fluid channel 30 distal to cold fluid port 28.

Cold secondary fluid channels 34 are fluidly connected to cold primary fluid channel 30 at cold branched region 32. Though the examples of FIGS. 1A and 1B show cold branched region 32 branching into four distinct layers of four cold secondary fluid channels 34, it should be understood that in other examples, alternate configurations are possible, including more or fewer cold secondary fluid channels 34 extending from cold branched region 32. Furthermore, cold secondary fluid channels 34 can extend radially from cold branched region 32 along a single plane or along multiple planes (to form a layered structure as shown in FIGS. 1A and 1B). As shown in the examples of FIGS. 1A and 1B, hot manifold 12 and cold manifold 14 can include the same number of layers of hot secondary fluid channels 24 and cold secondary fluid channels 34, respectively.

Cold secondary fluid channels 34 extend between cold branched region 32 of cold manifold 14 and core 16. Cold secondary fluid channels 34 can form a relatively straight path between cold branched region 32 and core 16 (i.e., so that cold manifold 14 and core 16 are oriented at 180 degrees) or the path can be curved, for example, as shown in FIGS. 1A and 1B at overlap region 36. Though the examples of FIGS. 1A and 1B show cold secondary fluid channels 34 turning 90 degrees to interface with core 16, such that cold manifold 14 is oriented at 180 degrees to hot manifold 12, it should be understood that in other examples, the angle between cold secondary fluid channels 34 and core 16 need not be 90 degrees (i.e., hot manifold 12 and cold manifold 14 need not be oriented at 180 degrees). Furthermore, hot manifold 12 and cold manifold 14 can also be oriented along different planes with respect to each other and/or with respect to core 16 (rather than a coplanar orientation as shown in FIGS. 1A and 1B).

As is most easily viewed in FIG. 1B, hot secondary fluid channels 24 and cold secondary fluid channels 34 are interleaved at hot overlap region 26 and cold overlap region 36. Hot overlap region 26 and cold overlap region 36 can correspond to the curved portion (as described above) of hot secondary fluid channels 24 and cold secondary fluid channels 34, respectively. Between hot branched region 22 and hot overlap region 26, layers of hot secondary fluid channels 24 are spaced apart such that a layer of cold secondary fluid channels 34 of cold manifold 14 can be disposed between two consecutive layers of hot secondary fluid channels 24. Consecutive layers of cold secondary fluid channels 34 are similarly spaced apart. Thus, at hot overlap region 26 and cold overlap region 36, layers of hot secondary fluid channels 24 and cold secondary fluid channels 34 form a stacked structure of alternating layers.

The stacked structure of alternating layers of hot secondary fluid channels 24 and cold secondary fluid channels 34 interfaces with core 16 at transition region 27. Transition region 27 forms an end of both hot secondary fluid channels 24 and cold secondary fluid channels 34 that is distal to hot branched region 22 and cold branched region 32. In alternative embodiments, hot manifold 12 and/or cold manifold 14 can be configured to include additional levels of branching and intervening fluid channels fluidly connected to hot secondary fluid channels 24 and/or cold secondary fluid channels 34 between hot branched region 22, cold branched region 32, and transition region 27. In some examples, hot manifold 12 and cold manifold 14 can have a fractal geometry defining the branching relationship between sequential levels of fluid channels.

Hot secondary fluid channels 24 and cold secondary fluid channels 34 can be generally tubular in structure to facilitate fluid flow. At transition region 27, hot secondary fluid channels 24 and cold secondary fluid channels 34 transition from having a circular cross-sectional area to a hexagonal cross-sectional area. Further, each hot secondary fluid channel 24 is continuous with a corresponding hot core channel 38 with a hexagonal cross-section, and each cold secondary fluid channel 34 is continuous with a corresponding cold core channel 42 with a hexagonal cross-section. Thus, hot secondary fluid channels 24 and cold secondary fluid channels 34 and corresponding hot core channels 38 and cold core channels 42 form a continuous fluid network.

Hot core channels 38 form hot flow layers 40A-40N of core 16. Each hot flow layer 40A-40N can correspond to a separate layer of hot secondary fluid channels 24 of hot manifold 12. Similarly, cold core channels 42 form cold flow layers 44A-44N of core 16. Each cold flow layer 44A-44N can correspond to a separate layer of cold secondary fluid channels 34 of cold manifold 14. Thus, in the example of FIG. 1A, core 16 is shown to include four hot flow layers 40A-40N and four cold flow layers 44A-44N. Specifically, as is best viewed in FIG. 1B, a first layer of hot secondary fluid channels 24 can correspond to a first one of hot flow layers 40A-40N (e.g., hot flow layer 40A), and a first layer of cold secondary fluid channels 34 (with respect to the same arbitrarily chosen side of heat exchanger 10) can correspond to a first one of cold flow layers 44A-44N (e.g., cold flow layer 44A).

Hot flow layers 40A-40N are spaced apart such that a single cold flow layer 44A-44N is disposed between two consecutive hot flow layers 40A-40N. Consecutive cold flow layers 44A-44N are similarly spaced apart. Thus, throughout core 16, hot flow layers 40A-40N and cold flow layers 44A-44N form a stacked structure of alternating layers arranged along parallel planes corresponding to each of hot flow layers 40A-40N and cold flow layers 44A-44N. For example, as shown in FIGS. 1A, 1B, and 2, cold flow layer 44A is disposed between hot flow layer 40A and hot flow layer 40B. Though the example of FIG. 1A shows hot flow layers 40A-40N and cold flow layers 44A-44N are arranged such that all layers (e.g., each of hot flow layers 40A-40N and cold flow layers 44A-44N) are parallel and all individual hot core channels 38 and cold core channels 42 follow a straight path within core 16, it should be understood that alternative core configurations are possible, including three-dimensional curved regions or separations within individual hot flow layers 40A-40N and/or cold flow layers 44A-44N.

In the examples of FIGS. 1A, 1B, and 2, core 16 is shown with a three-dimensional honeycomb geometry, but it should be understood that alternative embodiments can include other core types and/or geometries, particularly other layered geometries. Additionally, though the examples of FIGS. 1A and 1B illustrate heat exchanger 10 as including a single hot manifold 12 and a single cold manifold 14 connected to core 16, it should be understood that in other examples, heat exchanger 10 can include more than two manifold structures interfacing with core 16. Multiple manifold structures can be arranged in a substantially similar manner to hot manifold 12 and cold manifold 14 and can form additional layers of an interface with core 16.

The configuration and interleaved honeycomb geometry of core 16 is shown in greater detail in FIG. 2. FIG. 2 is a cross-sectional view of heat exchanger 10 taken at plane A-A of FIG. 1A. Each of hot core channels 38 and cold core channels 42 can have a regular hexagonal cross-sectional area (i.e., all walls and all interior angles (not labelled in FIG. 2) of each hot core channel 38 and cold core channel 42 can be congruent) defined by height T between opposite corners. Additionally, though the example of FIG. 2 shows core 16 with a uniform, interlocking, hexagonal cross-sectional geometry, it should be understood that other embodiments can have different cross-sectional geometries, including layers of interlocking triangles, squares, other polygons or combinations of polygons, or even irregular or curved shapes.

Adjacent hot core channels 38 are aligned such that a single wall forming a side of the cross-sectional hexagon is shared between adjacent hot core channels 38. Multiple adjacent hot core channels 38 are aligned in this way to form one of hot flow layers 40A-40N. Similarly, adjacent cold core channels 42 are aligned such that a single wall forming a side of the cross-sectional hexagon is shared between adjacent cold core channels 42. Multiple adjacent cold core channels 42 are aligned in this way to form one of cold flow layers 44A-44N.

Hot flow layers 40A-40N are arranged alternately with cold flow layers 44A-44N. As shown in FIG. 2, an adjacent pair of hot flow layers 40A-40N and cold flow layers 44A-44N can be offset by half the width of one channel (e.g., hot core channels 38, cold core channels 42), such that the cross-sectional hexagons of the adjacent pair of hot flow layers 40A-40N and cold flow layers 44A-44N are interlocking. Hot-cold interfaces N define shared walls between adjacent ones of hot flow layers 40A-40N and cold flow layers 44A-44N (e.g., between hot flow layer 40A and cold flow layer 44A in FIG. 2). When viewed in cross-section, hot-cold interface N can form a zigzag line with points corresponding to the interlocking corners of hot core channels 38 and cold core channels 42. Because adjacent hot flow layers 40A-40N and cold flow layers 44A-44N are interlocking along hot-cold interface N, the distance between adjacent hot flow layers 40A-40N and cold flow layers 44A-44N ranges from the length of one side of an individual channel (e.g., hot core channels 38, cold core channels 42) to height T.

With continued reference to FIGS. 1A, 1B, and 2, heat exchanger 10 is configured to permit the transfer of heat between hot fluid F_{H} and cold fluid F_{C}. For example, a transfer of heat can be associated with the use of hot fluid F_{H} and/or cold fluid F_{C} for cooling and/or lubrication of components in a larger system, such as a gas turbine engine or aerospace system. Hot fluid F_{H} and cold fluid F_{C} can be any type of fluid, including air, water, lubricant, fuel, or another fluid. Heat exchanger 10 is described herein as providing heat transfer from hot fluid F_{H} to cold fluid F_{C}; therefore, hot fluid F_{H} is at a greater temperature than cold fluid F_{C} at the point where hot fluid F_{H} enters heat exchanger 10. However, other configurations of heat exchanger 10 can include cold fluid F_{C} at a greater temperature than hot fluid F_{C} (and, thus, the “hot” and “cold” designations used herein would be reversed).

In the example of FIGS. 1A and 1B, heat exchanger 10 is shown receiving hot fluid F_{H} at hot fluid port 18 and discharging cold fluid F_{C} at cold fluid port 28 (i.e., a counter-flow arrangement). In other examples, the direction of flow of hot fluid F_{H} and/or cold fluid F_{C} can be reversed such that hot fluid F_{H} exits heat exchanger 10 at hot fluid port 18 and cold fluid F_{C} is received by heat exchanger 10 at cold fluid port 28. In yet other examples, heat exchanger 10 can be configured to interact with additional fluids, including along axes parallel or perpendicular to heat exchanger 10 (i.e., an additional counter-flow or a cross-flow arrangement, respectively, not shown in FIGS. 1A-2).

Hot fluid port 18 of hot manifold 12 is configured to receive or discharge hot fluid F_{H}. Hot fluid F_{H} entering hot manifold 12 at hot fluid port 18 is channeled through hot primary fluid channel 20 to hot branched region 22. At hot branched region 22, hot fluid F_{H} flows into hot secondary fluid channels 24. From hot branched region 22, hot fluid F_{H} flows within hot secondary fluid channels 24 through hot overlap region 26 to the interface with core 16 at transition region 27. In the examples of FIGS. 1A and 1B, hot fluid F_{H} flows directly from hot secondary fluid channels 24 into hot core channels 38 of hot flow layers 40A-40N.

Cold fluid port 28 of cold manifold 14 is configured to receive or discharge cold fluid F_{C}. Cold fluid F_{C} entering cold manifold 14 at cold fluid port 28 is channeled through cold primary fluid channel 30 to cold branched region 32. At cold branched region 32, cold fluid F_{C} flows into cold secondary fluid channels 34. From cold branched region 32, cold fluid F_{C} flows within cold secondary fluid channels 34 through cold overlap region 36 to the interface with core 16 at transition region 27. In the examples of FIGS. 1A and 1B, cold fluid F_{C} flows directly from cold secondary fluid channels 34 into cold core channels 42 of cold flow layers 44A-44N. Heat transfer between hot fluid F_{H} and cold fluid F_{C} can occur largely along hot-cold interfaces N of core 16.

In general, the interleaved structure of heat exchanger 10 retains the benefits of fractal geometry compared to traditional heat exchanger header configurations. Traditional heat exchanger headers, such as those with box-shaped manifolds, can have increased stress concentration at the interface between the manifold and the core, particularly at corners of the manifold where there is geometry discontinuity. The branching pattern of fractal heat exchanger manifolds, wherein each fluid channel is individually and directly connected to a passage in the core as shown in FIGS. 1A, 1B, and 2, can reduce this geometry discontinuity. Furthermore, each fluid channel in a fractal heat exchanger manifold (e.g., hot manifold 12 and cold manifold 14) behaves like a slim beam with low stiffness in transverse directions and reduced stiffness in horizontal directions due to the curved shape at each branched region. Thus, hot manifold 12 and cold manifold 14 have increased compliance (i.e., reduced stiffness) and experience less thermal stress compared to traditional heat exchanger header configurations.

Furthermore, the honeycomb geometry of core 16 with interleaved hot flow layers 40A-40N and cold flow layers 44A-44N has large hot-to-cold interaction surfaces (e.g., along hot-cold interfaces N) for a given volume. That is, there is ample surface area for heat transfer between hot fluid F_{H} and cold fluid F_{C} to occur. Thus, in applications wherein volume is a limiting factor, a heat exchanger with a honeycomb core as described herein can have increased efficiency relative to traditional heat exchanger configurations.

Heat exchanger 10 (and/or any component parts, including hot manifold 12, cold manifold 14, and core 16) can be formed partially or entirely by additive manufacturing. For metal components (e.g., nickel-based superalloys, aluminum, titanium, etc.) exemplary additive manufacturing processes include powder bed fusion techniques such as direct metal laser sintering (DMLS), laser net shape manufacturing (LNSM), electron beam manufacturing (EBM), to name a few, non-limiting examples. For polymer or plastic components, stereolithography (SLA) can be used. Additive manufacturing is particularly useful in obtaining unique geometries and for reducing the need for welds or other attachments (e.g., between a header and core). However, it should be understood that other suitable manufacturing processes can be used.

During an additive manufacturing process, heat exchanger 10 (and/or any component parts, including hot manifold 12, cold manifold 14, and core 16) can be formed layer by layer to achieve varied tubular dimensions (e.g., cross-sectional area, wall thicknesses, curvature, etc.). Each additively manufactured layer creates a new horizontal build plane to which a subsequent layer of heat exchanger 10 is fused. That is, the build plane for the additive manufacturing process remains horizontal but shifts vertically by defined increments (e.g., one micrometer, one hundredth of a millimeter, one tenth of a millimeter, a millimeter, or other distances) as manufacturing proceeds. The examples of FIGS. 1A and 1B show heat exchanger 10 already fully manufactured.

The interleaved geometry of heat exchanger 10 enables at least two fractal manifolds (e.g., hot manifold 12 and cold manifold 14) to be directly and individually connected to a honeycomb core (e.g., core 16). As such, heat exchanger 10 combines the benefits of both fractal and honeycomb geometries (as described above). The interleaved geometry also enables heat exchanger 10 to be additively manufactured as a single, monolithic unit. Additively manufacturing heat exchanger 10 as a single unit is particularly useful in that this process can reduce the need for welds, other attachments, or other manufacturing steps to combine components of heat exchanger 10 which would otherwise have been manufactured separately.

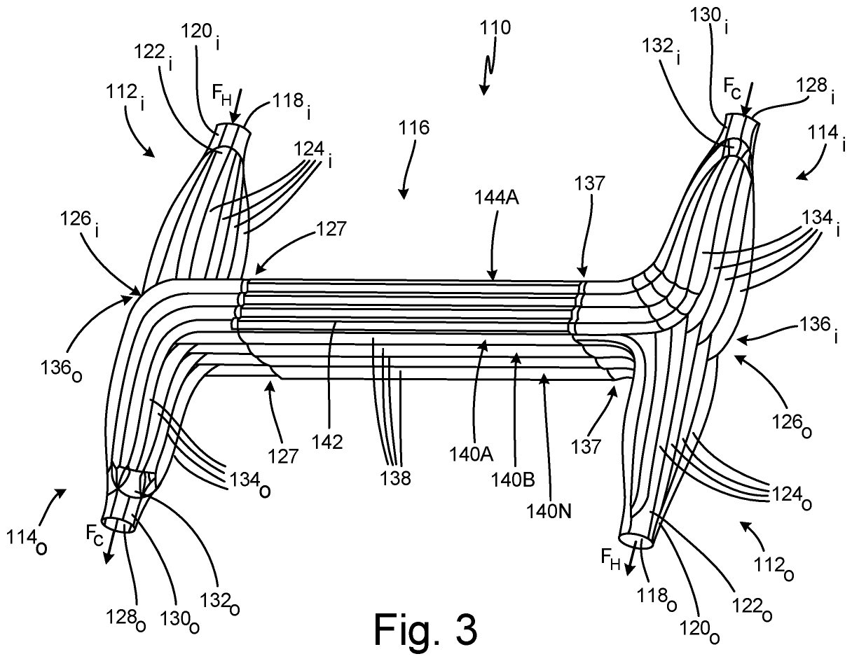

FIG. 3 is an isometric view of heat exchanger 110 including inlet and outlet manifolds and hot and cold flow layers. Heat exchanger 110 is substantially similar to heat exchanger 10, and additionally includes core 116 disposed between fluidly connected hot inlet manifold 112ᵢ and hot outlet manifold 112ₒ, and between fluidly connected cold inlet manifold 114ᵢ and cold outlet manifold 114ₒ.

In serial fluid communication with each of hot fluid inlet 118ᵢ and hot fluid outlet 118ₒ, (denoted in FIG. 3 with the applicable “i” or “o” subscript, but generally referred to herein solely by reference number) are hot primary fluid channel 120, hot branched region 122, hot secondary fluid channels 124, and hot overlap region 126. First transition region 127 forms an interface between hot inlet manifold 112ᵢ, cold outlet manifold 114ₒ, and core 116. In serial fluid communication with each of cold fluid inlet 128ᵢ and cold fluid outlet 128ₒ, (similarly denoted in FIG. 3 with the applicable “i” or “o” subscript, but generally referred to herein solely by reference number) are cold primary fluid channel 130, cold branched region 132, cold secondary fluid channels 134, and cold overlap region 136. Second transition region 137 forms an interface between hot outlet manifold 112ₒ, cold inlet manifold 114ᵢ, and core 116.

Hot core channels 138 of core 116 extend within hot flow layers 140A-140N between fluidly connected, corresponding hot secondary fluid channels 124. Cold core channels 142 of core 116 extend within cold flow layers 144A-144N between fluidly connected, corresponding cold secondary fluid channels 134. Generally, the ratio within heat exchanger 110 between inlet hot secondary fluid channels 124ᵢ hot core channels 138, and outlet hot secondary fluid channels 124ₒ, can be 1:1:1, such that an individual inlet hot secondary fluid channel 124ᵢ is connected to an individual hot core channel 138, and the individual hot core channel 138 is connected to an individual outlet hot secondary fluid channel 124ₒ. The ratio between inlet cold secondary fluid channels 134ᵢ, cold core channels 142, and outlet cold secondary fluid channels 134ₒ can also be 1:1:1, such that an individual inlet cold secondary fluid channel 134ᵢ is connected to an individual cold core channel 142, and the individual cold core channel 142 is connected to an individual outlet cold secondary fluid channel 134ₒ.

Thus, each of hot inlet manifold 112ᵢ and hot outlet manifold 112ₒ can include interleaved layers of hot secondary fluid channels 124 directly and individually connected to interleaved hot flow layers 140A-140N of core 116, as described above with reference to FIGS. 1A, 1B, and 2. Similarly, each of cold inlet manifold 114ᵢ and cold outlet manifold 114ₒ can include interleaved layers of cold secondary fluid channels 134 directly and individually connected to interleaved cold flow layers 144A-144N of core 116, as described above with reference to FIGS. 1A, 1B, and 2.

In the example of FIG. 3, hot inlet manifold 112ᵢ is oriented at 180 degrees to cold outlet manifold 114ₒ on the same side of core 116. On the other side of core 116, hot outlet manifold 112ₒ is oriented at 180 degrees to cold inlet manifold 114ᵢ. Hot inlet manifold 112ᵢ can be coplanar with and antiparallel to hot outlet manifold 112ₒ, such that the entire path from hot inlet manifold 112ᵢ, through core 116, and out hot outlet manifold 112ₒ forms an “S” shape. Cold inlet manifold 114ᵢ can also be coplanar with and antiparallel to cold outlet manifold 114ₒ, such that the path from cold inlet manifold 114ᵢ, through core 116, and out cold outlet manifold 114ₒ forms a mirrored (i.e., “backwards”) “S” shape.

In other words, hot outlet manifold 112ₒ is essentially transposed and mirrored across an axis through core 116 (not shown in FIG. 3) with respect to hot inlet manifold 112ᵢ. Similarly, cold outlet manifold 114ₒ is essentially transposed and mirrored across the same axis through core 116 with respect to cold inlet manifold 114ᵢ. However, because the relative configuration of the manifolds (e.g., hot inlet manifold 112ᵢ, hot outlet manifold 112ₒ, cold inlet manifold 114ᵢ, cold outlet manifold 114ₒ) is dependent, in part, on the three-dimensional geometry of core 116, it should be understood that in alternative embodiments, corresponding inlet and outlet manifolds can be oriented at different angles or even along different planes with respect to each other and/or with respect to core 116.

In a manner that is substantially similar to that described above with reference to FIGS. 1A, 1B, and 2, heat exchanger 110 is configured to permit the transfer of heat between hot fluid F_{H} and cold fluid F_{C}. In the example of FIG. 3, hot fluid F_{H} enters heat exchanger 110 at hot fluid inlet 118ᵢ. Hot fluid F_{H} passes through the branching tubular network (hot primary fluid channel 120ᵢ, hot branched region 122ᵢ, hot secondary fluid channels 124ᵢ, and hot overlap region 126ᵢ) of hot inlet manifold 112ᵢ, through core 116 within hot core channels 138, to the branching tubular network (hot overlap region 126ₒ, hot secondary fluid channels 124ₒ, hot branched region 122ₒ, and hot primary fluid channel 120ₒ) of hot outlet manifold 112ₒ, and exits heat exchanger 110 at hot fluid outlet 118ₒ. Heat exchanger 110 is configured such that hot fluid F_{H} encounters the same branching tubular network within hot outlet manifold 112ₒ as in hot inlet manifold 112ᵢ in reverse order.

Additionally, in the example of FIG. 3, cold fluid F_{C} enters heat exchanger 110 at cold fluid inlet 128ᵢ. Cold fluid F_{C} passes through the branching tubular network (cold primary fluid channel 130ᵢ, cold branched region 132ᵢ, cold secondary fluid channels 134ᵢ, and cold overlap region 136ᵢ) of cold inlet manifold 114ᵢ, through core 116 within cold core channels 142, to the branching tubular network (cold overlap region 136ₒ, cold secondary fluid channels 134ₒ, cold branched region 132ₒ, and cold primary fluid channel 130ₒ) of cold outlet manifold 114ₒ, and exits heat exchanger 110 at cold fluid outlet 128ₒ. Heat exchanger 110 is configured such that cold fluid F_{C} encounters the same branching tubular network within cold outlet manifold 114ₒ as in cold inlet manifold 114ᵢ in reverse order. Thus, heat exchanger 110 can have a counter-flow arrangement with hot fluid F_{H} and cold fluid F_{C} flowing through heat exchanger 110 in opposite directions.

In another example, the direction of flow of hot fluid F_{H} and/or cold fluid F_{C} can be reversed such that hot fluid F_{H} enters heat exchanger 110 at hot fluid outlet 118ₒ and exits at hot fluid inlet 118ᵢ and/or cold fluid F_{C} enters heat exchanger 110 at cold fluid outlet 128ₒ and exits at cold fluid inlet 128ᵢ, respectively. In yet other examples, heat exchanger 110 can be configured to interact with additional fluids, including along axes parallel or perpendicular to heat exchanger 110 (i.e., an additional counter-flow or a cross-flow arrangement, respectively, not shown in FIG. 3).

Thus, heat exchanger 110 is configured to facilitate the transfer of heat between hot fluid F_{H} and cold fluid F_{C} at core 116. Hot fluid F_{H}, exiting heat exchanger 110 at hot fluid outlet 118ₒ, and/or cold fluid F_{C}, exiting heat exchanger 110 at cold fluid outlet 128ₒ, can have final temperatures (e.g., after heat transfer has occurred and equilibrium is reached) that are suitable for cooling and/or lubrication of components in a larger system, such as a gas turbine engine or aerospace system.

Heat exchanger 110 presents the same benefits as described above in relation to heat exchanger 10, including multiple interleaved fractal manifolds (e.g., hot inlet manifold 112ᵢ and cold outlet manifold 114ₒ, and/or cold inlet manifold 114ᵢ and hot outlet manifold 112ₒ) directly and individually connected to honeycomb core 116. The addition of inlet and outlet manifolds on either end of core 116 of heat exchanger 110 allows for an efficient counter-flow arrangement that also takes advantage of the combination of fractal and honeycomb geometries. Furthermore, heat exchanger 110 can be additively manufactured as a single, monolithic unit. Accordingly, the techniques of this disclosure allow for heat exchanger 110 to have increased efficiency and to be manufactured more effectively compared to traditional heat exchanger configurations.

### Discussion of Possible Embodiments

The following are non-exclusive descriptions of possible embodiments of the present invention.

A heat exchanger includes a core, a first manifold, and a second manifold. The first manifold includes a primary fluid channel extending between a fluid port and a first branched region, a plurality of secondary fluid channels fluidly connected to the primary fluid channel at the first branched region, and a first overlap region of the plurality of secondary fluid channels downstream of the first branched region and connected to the core at a first transition region. The second manifold includes a primary fluid channel extending between a fluid port and a first branched region, a plurality of secondary fluid channels fluidly connected to the primary fluid channel at the first branched region, and a first overlap region of the plurality of secondary fluid channels downstream of the first branched region and connected to the core at a first transition region. The plurality of secondary fluid channels of the first and second manifolds are interleaved at the first overlap region such that a first layer of secondary fluid channels of the first manifold forms a first flow layer within the core, a first layer of secondary fluid channels of the second manifold forms a second flow layer within the core, and the first flow layer is adjacent and parallel to the second flow layer.

The heat exchanger of the preceding paragraph can optionally include, additionally and/or alternatively, any one or more of the following features, configurations and/or additional components:

The heat exchanger can further include a second layer of secondary fluid channels of the first manifold which forms a third flow layer within the core and a second layer of secondary fluid channels of the second manifold which forms a fourth flow layer within the core, and the third flow layer can be disposed between and can be adjacent and parallel to the second flow layer and the fourth flow layer.

The first, second, third, and fourth flow layers can each be formed of an equal number of secondary fluid channels.

Each of the plurality of secondary fluid channels can be tubular between the first branched region and the first transition region.

The first transition region can define a perpendicular plane through the plurality of secondary fluid channels at which a cross-sectional area of each of the plurality of secondary fluid channels is hexagonal.

The core can be a three-dimensional honeycomb structure.

The first manifold can be configured to receive or discharge a first fluid and the second manifold can be configured to receive or discharge a second fluid.

The first fluid and the second fluid flow can through the heat exchanger in opposite directions, such that the heat exchanger has a counter-flow arrangement.

Adjacent flow layers within the core can be configured to allow passage of one of the first fluid and the second fluid.

A heat exchanger core includes a plurality of cold flow layers extending between a cold inlet manifold and a cold outlet manifold and a plurality of hot flow layers extending between a hot inlet manifold and a hot outlet manifold. The plurality of hot flow layers and the plurality of cold flow layers are interleaved to form alternating hot and cold flow layers of the core.

The heat exchanger core of the preceding paragraph can optionally include, additionally and/or alternatively, any one or more of the following features, configurations and/or additional components:

The alternating hot and cold flow layers of the core can be parallel, and the core can be a three-dimensional honeycomb structure.

Each of the inlet and outlet manifolds can have a fractal geometry.

Each of the inlet and outlet manifolds can further include a primary fluid channel extending between a fluid port and a branched region and a plurality of secondary fluid channels fluidly connected to the primary fluid channel at the branched region and forming an interface with the core at a transition region.

Each of the plurality of secondary fluid channels can be tubular between the branched region and the transition region, and the transition region can define a perpendicular plane through the plurality of secondary fluid channels at which a cross-sectional area of each of the plurality of secondary fluid channels is hexagonal.

The hot inlet manifold can be disposed on an opposite side of the core from the cold inlet manifold.

The hot inlet manifold can be configured to receive a first fluid, and the cold inlet manifold can be configured to receive a second fluid.

The first fluid and the second fluid can flow through the heat exchanger in opposite directions, such that the heat exchanger has a counter-flow arrangement.

Each of the plurality of hot flow layers can be fluidly connected to corresponding secondary fluid channels of the hot inlet and outlet manifolds at the transition regions, and each of the plurality of cold flow layers can be fluidly connected to corresponding secondary fluid channels of the cold inlet and outlet manifolds at the transition regions.

Each of the plurality of hot flow layers and each of the plurality of cold flow layers can be formed of an equal number of secondary fluid channels.

A method can include constructing the heat exchanger core utilizing an additive manufacturing process, wherein the heat exchanger core can be configured to be additively manufactured as a single, monolithic unit.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heat exchanger comprising:
a core;
a first manifold comprising:
a primary fluid channel extending between a fluid port and a first branched region;
a plurality of secondary fluid channels fluidly connected to the primary fluid channel at the first branched region; and
a first overlap region of the plurality of secondary fluid channels downstream of the first branched region and connected to the core at a first transition region; and
a second manifold comprising:
a primary fluid channel extending between a fluid port and a first branched region;
a plurality of secondary fluid channels fluidly connected to the primary fluid channel at the first branched region; and
a first overlap region of the plurality of secondary fluid channels downstream of the first branched region and connected to the core at a first transition region;
wherein the plurality of secondary fluid channels of the first and second manifolds are interleaved at the first overlap region such that a first layer of secondary fluid channels of the first manifold forms a first flow layer within the core, a first layer of secondary fluid channels of the second manifold forms a second flow layer within the core, and the first flow layer is adjacent and parallel to the second flow layer.

2. The heat exchanger of claim 1, further comprising:
a second layer of secondary fluid channels of the first manifold which forms a third flow layer within the core; and
a second layer of secondary fluid channels of the second manifold which forms a fourth flow layer within the core;
wherein the third flow layer is disposed between and is adjacent and parallel to the second flow layer and the fourth flow layer.

3. The heat exchanger of claim 2,
wherein the first, second, third, and fourth flow layers are each formed of an equal number of secondary fluid channels.

4. The heat exchanger of claim 2,
wherein each of the plurality of secondary fluid channels is tubular between the first branched region and the first transition region.

5. The heat exchanger of claim 4,
wherein the first transition region defines a perpendicular plane through the plurality of secondary fluid channels at which a cross-sectional area of each of the plurality of secondary fluid channels is hexagonal.

6. The heat exchanger of claim 5,
wherein the core is a three-dimensional honeycomb structure.

7. The heat exchanger of claim 2,
wherein the first manifold is configured to receive or discharge a first fluid, and wherein the second manifold is configured to receive or discharge a second fluid.

8. The heat exchanger of claim 7,
wherein the first fluid and the second fluid flow through the heat exchanger in opposite directions, such that the heat exchanger has a counter-flow arrangement.

9. The heat exchanger of claim 8,
wherein adjacent flow layers within the core are configured to allow passage of one of the first fluid and the second fluid.

10. A heat exchanger core comprising:
a plurality of cold flow layers extending between a cold inlet manifold and a cold outlet manifold; and
a plurality of hot flow layers extending between a hot inlet manifold and a hot outlet manifold;
wherein the plurality of hot flow layers and the plurality of cold flow layers are interleaved to form alternating hot and cold flow layers of the core.

11. The heat exchanger core of claim 10,
wherein the alternating hot and cold flow layers of the core are parallel, and wherein the core is a three-dimensional honeycomb structure.

12. The heat exchanger core of claim 10,
wherein each of the inlet and outlet manifolds has a fractal geometry.

13. The heat exchanger core of claim 10,
wherein each of the inlet and outlet manifolds further comprises:
a primary fluid channel extending between a fluid port and a branched region; and
a plurality of secondary fluid channels fluidly connected to the primary fluid channel at the branched region and forming an interface with the core at a transition region.

14. The heat exchanger core of claim 13,
wherein each of the plurality of secondary fluid channels is tubular between the branched region and the transition region, and wherein the transition region defines a perpendicular plane through the plurality of secondary fluid channels at which a cross-sectional area of each of the plurality of secondary fluid channels is hexagonal.

15. The heat exchanger core of claim 13,
wherein the hot inlet manifold is disposed on an opposite side of the core from the cold inlet manifold.

16. The heat exchanger core of claim 15,
wherein the hot inlet manifold is configured to receive a first fluid, and wherein the cold inlet manifold is configured to receive a second fluid.

17. The heat exchanger core of claim 16,
wherein the first fluid and the second fluid flow through the heat exchanger in opposite directions, such that the heat exchanger has a counter-flow arrangement.

18. The heat exchanger core of claim 13,
wherein each of the plurality of hot flow layers is fluidly connected to corresponding secondary fluid channels of the hot inlet and outlet manifolds at the transition regions, and wherein each of the plurality of cold flow layers is fluidly connected to corresponding secondary fluid channels of the cold inlet and outlet manifolds at the transition regions.

19. The heat exchanger core of claim 18,
wherein each of the plurality of hot flow layers and each of the plurality of cold flow layers are formed of an equal number of secondary fluid channels.

20. A method comprising:
constructing the heat exchanger core of claim 10 utilizing an additive manufacturing process;
wherein the heat exchanger core is configured to be additively manufactured as a single, monolithic unit.
